(19) United States
(12) Patent Application Publication
(10) Pub. No.: US 2016/0063421 A1
(43) Pub. Date: Mar. 3, 2016

(54) SYSTEMS AND METHODS FOR SERVICE LEVEL AGREEMENT FOCUSED DOCUMENT WORKFLOW MANAGEMENT

(71) Applicant: Xerox Corporation, Norwalk, CT (US)

(72) Inventors: Atul Singh, Bangalore (IN); Anirban Mondal, Bangalore (IN); Kuldeep Yadav, Gurgaon (IN); Deepthi Chander, Cochin (IN); Koustuv Dasgupta, Bangalore (IN); Nischal Murthy Piratla, Fremont, CA (US); Om Deshmukh, Bangalore (IN)

(21) Appl. No.: 14/468,456

(22) Filed: Aug. 26, 2014

(51) Int. Cl. G06Q 10/06

(52) U.S. Cl. CPC G06Q 10/06316

(57) ABSTRACT

Systems and methods for managing document workflows is disclosed. The method includes configuring and deploying a document workflow based on at least one service level agreement (SLA) parameter. The document workflow includes one or more document processing tasks. The method also includes establishing communication between the configured document workflow and a document management system. The method further includes retrieving a document from the document management system in response to at least one service request received from a first user role. The method furthermore includes accessing the retrieved document to perform the one or more document processing tasks by a second user role. The method also includes generating at least one of a notification and an alert based on statuses of the one or more document processing tasks with respect to the at least one SLA parameter.

### TECHNICAL FIELD

Some of the disclosed embodiments relate to workflow management systems, and more particularly to methods and systems for document workflow management systems.

### BACKGROUND

It is often necessary for individuals, such as customers, to submit multiple documents in order to obtain various types of services, including but not limited to account openings, loan/mortgage requests, user/member registrations, insurance claims, etc. Various types of business enterprises or organizations, such as banks, hospitals, etc., may provide these services. The customer's submission of documents initiates a complex workflow involving multiple agents (both human and software) within the enterprise or organization. The workflow constitutes a document intensive process that involves multiple document processing steps. For example, a typical mortgage request requires the customer to submit multiple documents, such as identity proof, address proof, or the like, that initiate a workflow involving multiple steps, such as processing of the documents for validity, approval by an appropriate agent, and the like. In addition, it may be difficult to track the progress of the workflow, as well as to identify and correct service level agreement (SLA) violations within the workflow.

### SUMMARY

While it is possible to integrate a workflow with a document management system, it is typically extremely complex and cumbersome to actually accomplish this integration in the contexts of disparate technologies, regulatory compliance challenges, etc. In addition, typical document management systems do not cater to enterprise workflows that require the handling of a variety of documents in a trusted manner in multiple stages of the flow. Furthermore, the requirements of Service Level Agreements (SLAB) that contractually bind the enterprise with its customers for the timely execution of the workflows are not integrated in typical document management systems. Moreover, there is technical and business value in moving the execution of the business workflows to a third-party-managed end-to-end service, thereby relieving the business enterprise or organization from expending resources in handling workflow execution activities and enabling them to focus on more productive activities that enhance their core business.

It may therefore be beneficial to provide document workflow modeling systems. Thus, some embodiments are directed to methods and apparatus for providing succinct and powerful processes for seamlessly capturing and handling document intensive workflows. Some of these embodiments effectively integrate the modeling of document intensive workflows, such as opening a bank account, obtaining a mortgage or loan, etc., with secured and seamless workflow execution, thereby providing end-to-end document workflow management services for an organization. Some of these methods and apparatus enable easy and secure access to documents through document banking for workflow execution.

Some of these methods and apparatus simplify the modeling of a document-intensive workflow by envisioning it as a process, which includes functional roles and relevant documents being passed between these roles. As one example in the context of a workflow directed to opening a bank account, functional roles can include a bank clerk, document verification officer, account opening approval officer, etc. Documents pass between these roles in the following order: user, bank clerk, document verification officer, and account opening approval officer. These methods and apparatus enhance the workflow modeling by providing a modeling construct for representing document processing tasks. Some of these embodiments enable easy annotation of the task with service level agreements, and roles to send alerts in case of time-based violations. Some of these embodiments are also able to notify users upon completion of different processing stages in any lifecycle of their documents on a per-document basis.

Some embodiments allow users to store, manage, and perform tasks related to workflows that include sets of documents. The focus of an associated interface is on workflows that may be executed by a single user on an ordered set of documents. However, the disclosed methods and apparatus deal with business workflows that typically involve multiple users acting on multiple documents, such that a single document is often processed by multiple users in parallel. Thus, these embodiments provide an enhancement over the related art that does not track and ensure service level agreements associated with the document processing tasks.

Some of the embodiments provide document workflow management systems and methods with user access control. Some of these embodiments deal with workflows that involve multiple users acting sequentially on a single document stored in a repository. However, the disclosed embodiments deal with business workflows that typically involve multiple users acting on multiple documents, such that a single document is often processed by my multiple users in parallel. Some of these embodiments provide workflow management systems and methods in which a workflow and corresponding roles can be created. The embodiments also support communicating notifications or alerts via emails, SMS messages, etc., during a workflow instance for transmitting a message to a user or a user role of a subsequent work stage whenever a given task is complete. Some of the embodiments therefore provide a powerful modeling approach and present a novel construct to represent workflow steps that capture the execution of document processing tasks. The specific construct allows the step to be assigned to any user from a set of users to maintain a variety of service level agreements and quality. The service level agreement adherence can be tracked via a graphical interface, and monitored by one or more users.

One exemplary embodiment includes a device for managing document workflows. The device is for use with a communication network. The device includes a workflow editor, an integration module, and a runtime engine. The workflow editor configures a document workflow based on at least one service level agreement (SLA) parameter. The configured document workflow includes one or more document processing tasks. The integration module is configured to (1) establish communication between the configured document workflow and a document management system, and (2) retrieving a document from the document management system in response to at least one service request. The runtime engine is configured to (1) execute the one or more document processing tasks on the retrieved document according to the configured document workflow, (2) generate at least one of a notification and an alert based on statuses of the one or more document processing tasks with respect to the at least one SLA parameter.

Another exemplary embodiment includes a method for managing document workflows. The method includes configuring and deploying a document workflow based on at least one service level agreement (SLA) parameter. The document workflow includes one or more document processing tasks. The method also includes establishing communication between the configured document workflow and a document management system. The method further includes retrieving a document from the document management system in response to at least one service request received from a first user role. The method furthermore includes accessing the retrieved document to perform the one or more document processing tasks by a second user role. The method also includes generating at least one of a notification and an alert based on statuses of the one or more document processing tasks with respect to the at least one SLA parameter.

Yet another exemplary embodiment includes a system for managing a document workflow in a network of computing devices. The system includes a host device including a document management system, and a client device in communication with the host device. The client device is configured with an administrator interface, a customer interface, and an agent interface. The administrator interface assists to configure and deploy a document workflow based on at least one service level agreement (SLA) parameter. The configured document workflow includes at least one document processing task. The configured document workflow is integrated with the document management system. The customer interface assists to send a service request for retrieving a document from the document management system. The host device is configured to (1) retrieve the document based on the service request, (2) provide the retrieved document for the at least one document processing task, and (3) execute the at least one document processing task according to the document workflow based on an agent input. The agent interface assists to receive a notification based on the at least one document processing task and the retrieved document being available for access.

Other and further aspects and features of the disclosure will be evident from reading the following detailed description of the embodiments, which are intended to illustrate, not limit, the present disclosure.

### BRIEF DESCRIPTION OF THE DRAWINGS

FIG. 1A is a schematic of a document banking system including an exemplary workflow manager, according to an embodiment of the present disclosure.

FIG. 1B is a schematic of an exemplary framework for a document processing task, according to an embodiment of the present disclosure.

FIG. 2 is a schematic of the exemplary workflow manager of FIG. 1, according to an embodiment of the present disclosure.

FIG. 3 is a flow chart illustrating an exemplary method for operating the workflow manager of FIG. 1, according to an embodiment of the present disclosure.

FIG. 4 is a schematic that illustrates a typical workflow for opening a new bank account according to an embodiment of the present disclosure.

FIG. 5 is a schematic that illustrates a first exemplary interface of the workflow manager of FIG. 1 for an administrator, according to an embodiment of the present disclosure.

FIG. 6 is a schematic that illustrates an exemplary document workflow for opening a new bank account, according to an embodiment of the present disclosure.

FIG. 7 is a schematic that depicts a second exemplary interface of the workflow manager of FIG. 1 for the administrator, according to an embodiment of the present disclosure.

FIG. 8 is a schematic that depicts a first exemplary interface of the workflow manager of FIG. 1 for an agent, according to an embodiment of the present disclosure.

FIG. 9 is a schematic of a second exemplary interface of the workflow manager of FIG. 1 for the agent, according to an embodiment of the present disclosure.

FIG. 10 is a schematic an exemplary interface of the workflow manager of FIG. 1 for a customer, according to an embodiment of the present disclosure.

### DETAILED DESCRIPTION

The following detailed description is provided with reference to the figures. Exemplary, and in some cases preferred, embodiments are described to illustrate the disclosure, not to limit its scope, which is defined by the claims. Those of ordinary skill in the art will recognize a number of equivalent variations in the description that follows.

### NON-LIMITING DEFINITIONS

Definitions of one or more terms that will be used in this disclosure are described below without limitations. One of ordinary skill in the art will understand that the following definitions are merely provided for clarity, and are not intended to constitute an exhaustive list of exemplary embodiments and applications.

The term “document banking” deals with handling of one or more documents such as storing documents, transferring documents, sharing documents, downloading documents or the like, without any limitations.

The term “document” refers to any document including an electronic document without limitations. Further, the “document” may be a document having a single page or multiple pages, each page including text, images, or a combination thereof.

The term “document management system” refers to any system capable of handling activities related to documents such as storing documents, transferring documents, receiving documents, billing and payment related activities, verifying documents, or the like.

The term “document workflow” refers to steps involved in processing of documents by one or more users according to a business process of an organization.

A “document bank account” is a document account between a user and the document banking system. The “document bank account” maintains one or more documents related to the user. The “user” may be any individual or an entity that has a “document bank account” with the “document banking system”. For example, the entity can be any organization such as visa organization, passport organization, banking organization or any organization that deals with documents.

A term “computing device” includes any electronic system capable of handling electronic documents. Various examples include mainframe computers, rack servers, cloud servers, desktop computers, smart phones, tablets, Personal Digital Assistant (PDA), laptops, or the like.

A term “network” is intended to include any communication link between more than one computing devices. The network may be a wireless or a wired network, or a combination thereof. The network may be a collection of individual networks, interconnected with each other and functioning as a single large network (e.g., the Internet or an intranet). Various examples of a network include, a local area network (LAN), Wide area network (WAN), Metropolitan area network (MAN), cable/telephone network, satellite network, or the like.

A term “host device” refers to any networked computing device that hosts various applications and can provide service to, and request services from, other devices connected to the network. Various examples of the host device include a personal computer, a workstation, or a server, etc.

A term “client device” refers to any computing device that can communicate with the host device to access documents. Examples of the client device include a desktop PC, a personal digital assistant (PDA), a mainframe computer, a mobile computing device, an internet appliance, an automatic teller machine (ATM), etc.

An “application” can be any computer program executing on the client device which is configured for enabling a user to access, upload, edit, download, transfer or transact the documents or the like.

A term ‘agent’ may represent an employee of an organization or business enterprise having a functional role. For example, in a bank, an agent can be a bank employee having a functional role, such as a bank clerk, document verification officer, account opening approval officer, bank manager, or the like.

### OVERVIEW

Some of the disclosed embodiments relate to managing document workflows for various business processes in enterprises and organizations such as, banks, government departments, manufacturing firms, service firms, or the like. For example, a document intensive workflow in a bank is opening of a new account for a customer. The new account opening workflow includes various document processing tasks, such as verification of address proof, credit check or the like. Some embodiments of the disclosure facilitate and monitor the document workflows by integrating the document workflows in a document banking system. More particularly, the embodiments of the disclosure include a document workflow manager configured to manage document workflows. The document workflow manager includes a workflow editor that can create custom workflows and accepts SLA parameter inputs for creating the document workflows. Additionally, the document workflow manager includes a document banking integration module for integrating the document workflows created by the workflow editor to the document banking system. Further, the document workflow manager includes a runtime engine that processes service requests and the attached documents, for example, a bank account opening request, and generate notifications and document processing tasks for various agents in an organization, for example, a bank. Furthermore, the document workflow manager includes a status monitor for monitoring the status of various document processing tasks in the document workflows.

### EXEMPLARY EMBODIMENTS

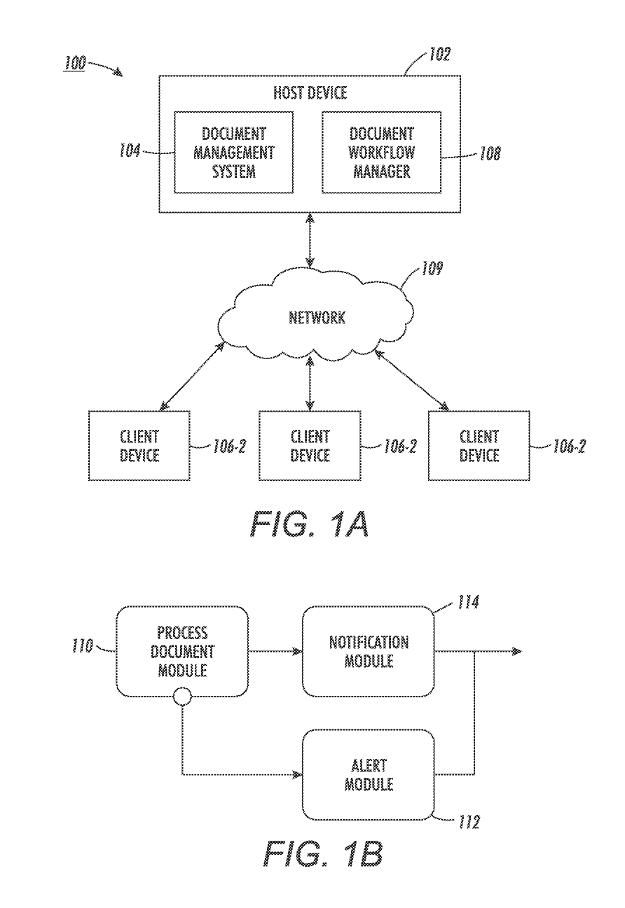

FIG. 1A is a schematic of a network environment 100 including an exemplary document workflow manager, according to an embodiment of the present disclosure. Embodiments are disclosed in the context of a host device 102 including a document management system 104 in communication with one or more client devices 106-1, 106-2, and 106-3 (client devices 106). The embodiments may be applied in various business scenarios including, but are not limited to, bank agents handling customer documents, hospital agents handling patient documents, retail agents handling customer's membership documents, property consultants handling customer's property documents, etc.

In an embodiment, the document management system 104 may operate in communication with a document workflow manager 108 configured to model and manage document-intensive business workflows that are executed based on predefined service level agreement (SLA) parameters. Examples of such SLA parameters include, but are not limited to, time duration for task completion, distribution ratio of tasks among a worker pool for a role, authorized users, users for notifications, and documents to be processed. Such document workflows may include various document processing tasks that are executed by users based on their functional roles (hereinafter referred to as user roles), such as an administrator, a customer, an agent, etc. configured by the document workflow manager 108. One exemplary framework for a document processing task is shown in FIG. 1B to include a process document module 110 configured to perform a predefined operation on an input document. The document processing task may also include pre-build support modules such as an alert module 112 and a notification module 114 for providing advanced functionalities. The alert module 112 may be configured to generate an alert to intimate a user role, such as a supervisor, the agent, the administrator, etc., that the task does not meet the predefined SLA parameters, or in other words, violates the SLA. The alert module 112 may be also configured to alert a user role when a new task is assigned to the user role. The notification module 114 may be configured to send a notification to a user role, such as a customer, associated with a task being executed. Details of the user role to which the notification is to be sent may be provided in a user account of the document management system 104. The notification module 114 may be further configured to send the notification to a user role responsible for handling the next task in the workflow sequence. Some embodiments may include both the notification module 114 and the alert module 112 configured to send the respective notifications and alerts either to the same or different user roles. Each of the generated alert and the notification may include at least one a message, an audio indication, and a visual indication. In some embodiments, the document processing task may update any document created, updated, or uploaded by the user role (e.g., a scribbled note written by the user role on the document), in databases of the document management system 104.

The user roles may be assigned to users using their user accounts, which may be preconfigured or dynamically configured in at least one of the document management system 104 and the document workflow manager 108. The user roles may represent real-life functional roles of the users in an organization. For example in a bank, the real-life functional roles of a user may include bank clerk, document verification officer, account opening approval officer, etc. The document workflow manager 108 may be configured to assign distinct access privileges to each of the user roles for controlling user access to (1) the documents in the document management system 104, and (2) the document processing tasks. Multiple users may simultaneously access the document workflow manager 108 via the document management system 104 or a suitable interface by using the client devices 106. Such interface may include one of a variety of software interfaces, for example, application programming interface, graphical user interface; hardware interfaces, for example, cable connectors, a keyboard, a card reader, an interactive display screen, etc.; or both. Additionally, the interface may include a web interface accessed using the client devices 106 over a network 109.

The document workflow manager 108 may be implemented as a standalone and dedicated “black box” including hardware and installed software, where the hardware is closely matched to the requirements and/or functionality of the software. The document workflow manager 108 may enhance or increase the functionality and/or capacity of the network 109 to which it is connected. The document workflow manager 108 may be configured, for example, to perform e-mail tasks, security tasks, network management tasks including IP address management, and other tasks. In some embodiments, the document workflow manager 108 is configured to expose its operating system or operating code to a user for access. The document workflow manager 108 of some embodiments may, however, include software, firmware or other resources that support remote administration and/or maintenance of the document workflow manager 108. Other embodiments may implement the document workflow manager 108 to include, in whole or in part, a software application working alone or in conjunction with one or more hardware resources. Such software applications may be executed by a processor on different hardware platforms or emulated in a virtual environment. Aspects of the document workflow manager 108 may leverage off-the-shelf software available in the art, related art, or developed later.

In some embodiments, the document workflow manager 108 implemented as a device may be integrated with the host device 102 or the document management system 104. Other embodiments may involve the client devices 106 being preconfigured or dynamically configured to include the document workflow manager 108 integrated with other devices. For example, the document workflow manager 108 may be integrated with the host device 102 or a network appliance (not shown) such as a modem, a router, a gateway, etc. The host device 102 may include a module (not shown) that enables the host device 102 or the network appliance being introduced to the client devices 106, thereby enabling the client devices 106 to invoke the document workflow manager 108 as a service.

The document workflow manager 108 may communicate with databases or storage units (not shown) associated with the document management system 104 or the host device 102 for storing the documents navigating through the document workflows or accessing the stored documents. Examples of the storage units include, but are not limited to, storage servers connected to the network 109, portable storage devices, local storage space, for example, memory, on the host device 102, etc.

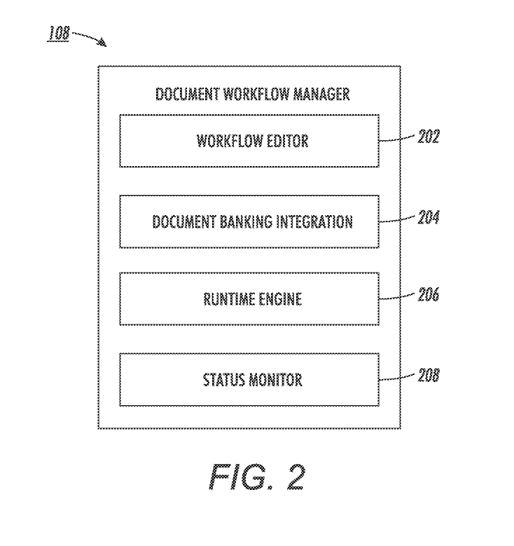

Turning to FIG. 2, the document workflow manager 108 may include various modules for modeling and managing different document workflows. In an embodiment, the document workflow manager 108 includes a workflow editor 202, an integration module 204, a runtime engine 206, and a status monitor 208. The workflow editor 202 may be configured to perform various operations, such as modeling, editing, saving, deploying, undeploying, etc., on the document workflows based on one or more SLA parameters. For example, the document workflow manager 108 may be used in a bank to create a document workflow for opening a new account, mortgage application processing, etc. Further, the workflow editor 202 may be configured to define customized document processing tasks within each of the document workflows based on one or more SLA parameters. In some embodiments, the workflow editor 202 may be configured to create annotations of the document processing tasks along with the SLA parameters. Such annotations may include text, an image, a multimedia content, or a combination thereof. Other embodiments of the workflow editor 202 may be configured to generate or assess stored symbols for creating a document-intensive workflow. The symbols may be stored in the database associated with at least one of the document management system 104 and the document workflow manager 108.

Symbols may be associated with packets, headers, fields, information, states, or the like defined by a preconfigured or dynamically configured protocol that executes the symbols to perform a predefined functionality within the underlying hardware or software or network environment. In this context, a symbol is a graphical or other abstract visual representation of one or more modules, tasks, document flows, etc. in the document-intensive workflow. Symbols may be constructed by varying a wide variety of characteristics including, but not limited to, shapes, sizes, in-fill, line type, line width, color, orientation, etc. For example, as shown, the modules such as the process document module 110, the alert module 112, and the notification module 114 may be represented by rectangles with round corners. Accordingly, the symbols may be used to symbolically represent the document workflow.

Such symbolic representation of the workflow may include a representation of the predefined protocol-specific information and thus have meaning extending beyond the individual symbols themselves. For example, symbols representing tasks or modules such as the process document module 110 and the notification module 114 may be displayed from left to right on a display according to the time a document or a document pack is received. Thus, through the placement of symbols in relationship to one another, the user may visually comprehend a time relationship between the modules. In some embodiments, the distance between the positioned symbols may be proportional to time. Other embodiments may include the symbols being associated with or further include labels, numbers, text, symbols, and other elements for visually representing the function or meaning of the symbol. For example, a module represented as a rectangle may include and display the representative name of that module.

The runtime engine 206 may include a program or set of instructions processed to execute the modeled document workflows on a software platform, such as Microsoft Windows, Linux, etc., or within a Virtual Machine. The runtime engine 206 may be configured to implement the SLA parameters, to implement the defined document processing tasks within the document workflows for execution, raise alerts, and send notifications to one or more user roles when the SLA parameters are not adhered. In some embodiments, the runtime engine 206 may predict future availability of a user role, such as an agent, based on a number of factors. For example, some factor in prediction of future availability of an agent may include average time taken by the agent to perform a task, volume of service requests from customers in different months of a year, leave requests by various agents, experience of the agents, quality requirements of the SLA, time of task completion, distribution ratio of tasks among agents or the like.

The status monitor 208 may be configured to interact with the runtime engine 206 to provide the status of document processing tasks or the document workflows as a whole to the user roles. The status monitor 208 may store the status information in the document workflow manager 108. The status information may include task initiation, task progress, task completion, task delays, or the like. Additionally, the status monitor 208 may store information about the agents allocated with the document processing tasks. The status information may be checked by any of the user roles, for example, administrator, agent, or the customer, on any of the client devices 106 in their respective graphical interfaces. The status monitor 208 may provide the status through a variety of software and hardware interfaces such as those mentioned above. The status may be displayed to the user roles based on user requests or automatically at predefined conditions, such as, at predefined time intervals, at task completion, at the completion of the document workflow, etc.

The integration module 204 may be configured to integrate the document workflow manager 108 with a document management system 104 such as the document management system 104. The integration module 204 may communicate with various databases of the document management system 104 in response to user requests. The integration module 204 may be configured to convert user requests into appropriate formats compatible with the databases. Consequently, the integration module 204 allows implementation of the databases using different technologies or by different organizations, for example, a third-party vendor managing a particular database using a proprietary technology. These databases may store documents in various database schema such as relational databases schema. Examples of such databases may include, but are not limited to, EEPROM, flash memory, cache memory, SD-RAM, DDR-RAM, or storage units such as those mentioned above.

Other embodiments of the document workflow manager 108 may include additional or other modules without departing from the spirit and scope of the present disclosure.

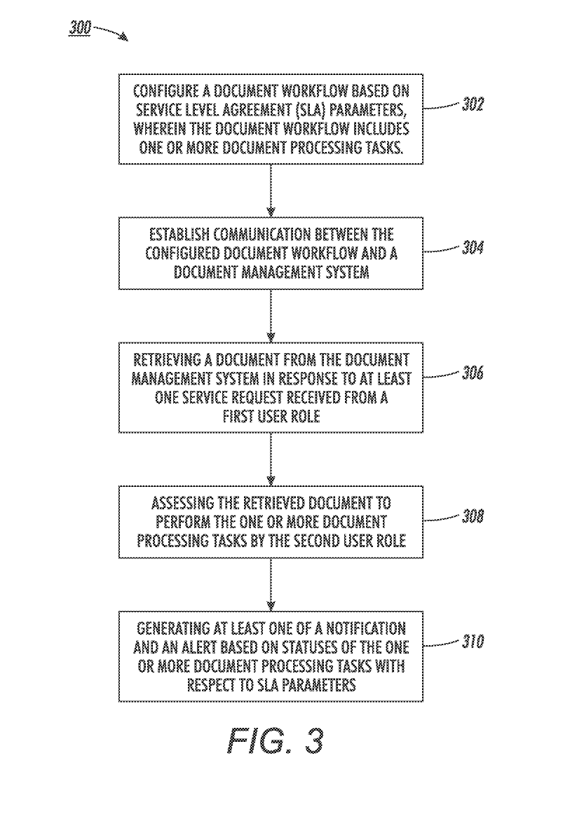

FIG. 3 is a flow chart illustrating an exemplary method for operating the document workflow manager 108 of FIG. 1, according to an embodiment of the present disclosure. The exemplary method may be described in the general context of computer executable instructions. Generally, computer executable instructions may include routines, programs, objects, components, data structures, procedures, modules, functions, and the like that perform particular functions or implement particular abstract data types. The computer executable instructions may be stored on a computer readable medium, and installed or embedded in an appropriate device for execution.

The order in which the method is described is not intended to be construed as a limitation, and any number of the described method blocks may be combined or otherwise performed in any order to implement the method, or an alternate method. Additionally, individual blocks may be deleted from the method without departing from the spirit and scope of the present disclosure described herein. Furthermore, the method may be implemented in any suitable hardware, software, firmware, or combination thereof, that exists in the related art or that is later developed.

The method describes, without limitation, implementation of the exemplary document workflow manager 108 in a banking environment. One of skill in the art will understand that the method may be modified appropriately for implementation in a variety of other business scenarios including those related to medical services, hospitality, retail, and so on, without departing from the scope and spirit of the disclosure.

At step 302, a document workflow based on the SLA parameters is created. The document workflow manager 108 may be accessed by users from a client device, such as the client device 106-1, or directly at the host device 102 via the suitable interface. The document workflow manager 108 may receive the SLA parameters from the users. The document workflow manager 108 includes the workflow editor 202 that receives the SLA parameters to create the SLA-bound document workflow by using the generated or stored predefined symbols. The users may access the workflow editor 202 to edit, remove, save, or deploy the created workflow. Further, the workflow editor 202 may be used to configure the document processing tasks in the document workflow. The document processing tasks may operate based on one or more of the SLA parameters, and are executed by the redefined user roles.

At step 304, the created document workflow is integrated with the document management system 104. The document workflow manager 108 includes the integration module 204 that facilitates communications between the document workflow manager 108 and the databases associated with the document management system 104 or the host device 102. In some embodiments, the integration module 204 may convert the document requests into appropriate formats compatible with the databases and communicate the requests to the databases for retrieving the requested documents and information, such as user profile data, user organization data, etc.

At step 306, a document from the integrated document management system 104 is retrieved in response to at least one service request generated by a first user role. A first user role may generate a service request from the client devices 106 for the document workflow manager 108 to retrieve a document. For example, customers of a bank may generate a service request to retrieve property documents for a mortgage application workflow. The integration module 204 may receive the service request and communicates with the databases of the document management system 104 to retrieve the requested document.

At step 308, the retrieved document is accessed to perform the one or more document processing tasks by a second user role. The retrieved document may be fed to the document workflow based on the service request from the first user role. The runtime engine 206 executes the requested workflow, such as the mortgage application workflow, and provides the retrieved document for being accessed by the second user role, such as an agent in a banking scenario, to perform one or more document processing tasks designated for the second user role.

At step 310, at least one of a notification and an alert is generated based on statuses of the one or more document processing tasks with respect to the SLA parameters. The document processing tasks are bound by the SLA parameters, which trigger the notification module 114 or the alert module 112 based on the status of these tasks being performed by the second user role, such as the agent. For example, a particular document processing task may be bound by an SLA parameter directed towards the task to be completed in three days. In one scenario, if the second user role is unable to complete the document processing task in three days, the runtime engine 206 may trigger the alert module 112 to generate an alert to another user or user role, for example, a supervisor. In another scenario, if the task is completed within three days and SLA parameter is fulfilled, the runtime engine 206 may trigger the notification module 114 to notify the first user role, such as the customer, about the task completion along with completion data. The completion data may include a next task to be performed on the document, a next user or user role responsible for undertaking that next task, a list of tasks to be performed on the document, expected completion time of the next task, etc.

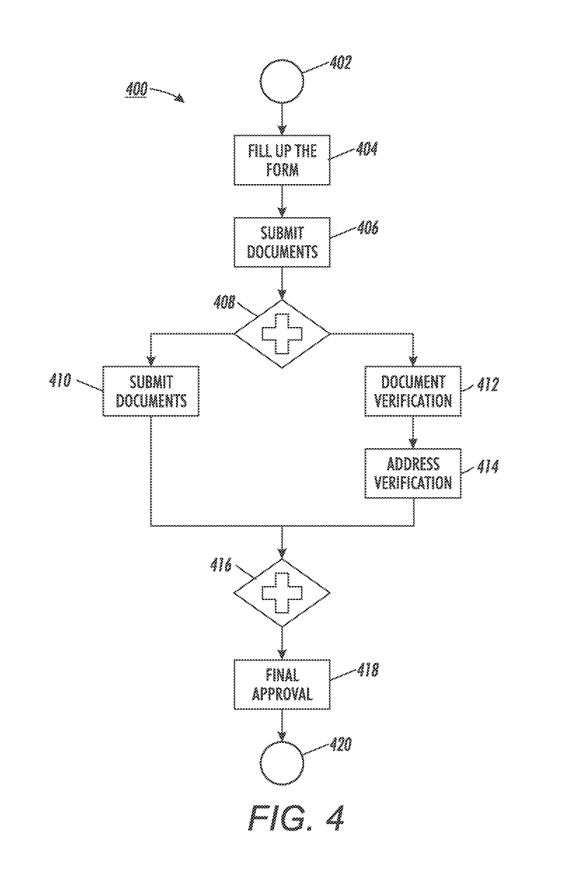

FIG. 4 illustrates a typical account opening business process in a bank. The starting step 402 in the process includes a customer visiting a bank's facility or login into the bank's website. The customer fills in an application form in the next step 404, and submits the required documents, such as social security number (SSN), proof of address, and proof of identity, in physical or electronic form to the bank in the subsequent step 406. Next, in step 408, the documents and the application form are collected by a bank agent and a service request for opening a new account is initiated. The documents are forwarded to other agents in the bank for further processing. Some of the processing steps include a step 410 in which a bank agent performs a credit check on the customer. Similarly, the processing steps include a step 412 for document verification, and a step 414 for address verification. These steps 410, 412, and 414 may be performed by a number of ways in the bank. In some banks, these steps 410, 412, and 414 are performed consecutively, and in other banks these steps 410, 412, and 414 are performed in tandem. In some scenarios, each of the above steps may be performed by a single agent or multiple agents. The processed documents are collated at step 416 and sent for final approval of the appropriate bank agent, for example, account opening approval officer in the subsequent step 418. After approval of the documents and the application form, a new bank account is opened for the customer at step 420.

Although not shown in FIG. 4, the process of opening a bank account is governed by various clauses of the service level agreement (SLA) that is signed and approved by the customer in step 404, such as at the time when the application form is filled by the customer. The clauses of the SLA bind the bank to operate all business processes in a timely manner with an acceptable level of quality. For example, the bank may be bound by the SLA to complete the process of account opening in three working days. In such a case, the agents within the bank get a finite fraction of the three working days to finish the document processing tasks assigned to them. Sometimes, in large organizations/banks with a large number of agents working on multiple document processing tasks in tandem, tracking delays in the document processing tasks and ensuring that all SLA clauses are met becomes difficult.

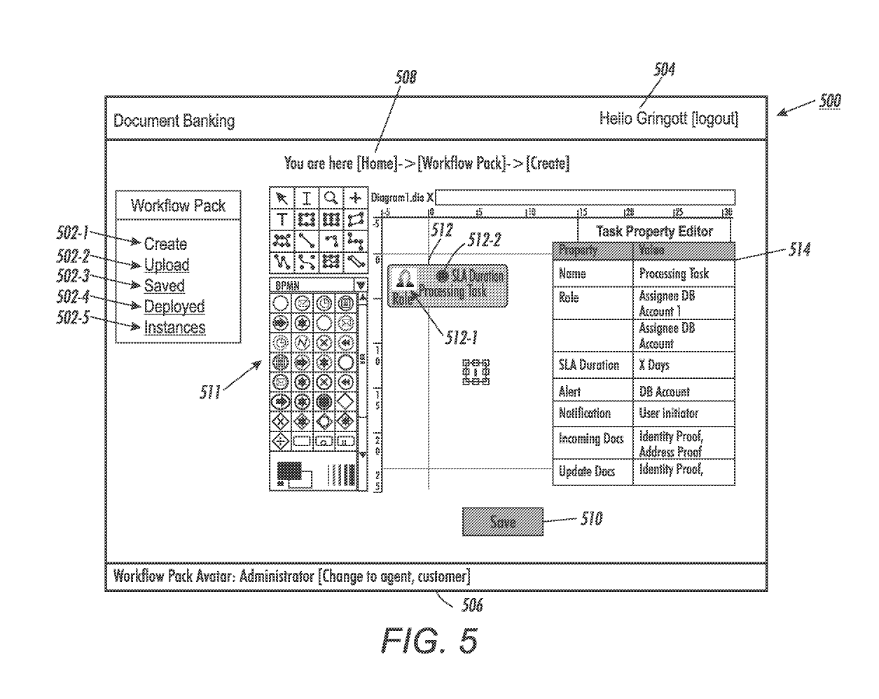

In contrast to the typical process of FIG. 4, the disclosed system 100 may assist in automating and monitoring document processing tasks, improve performance of the document processing tasks, track delays and check whether the SLA's are met or not. As discussed, a user may access the document management system 104 or the document workflow manager 108 through one of the client devices 106. Upon such access, an interactive graphical interface 500 (shown in FIG. 5) may be displayed on one of the accessed client devices 106, such as client device 106-1 over the network 109. The interface 500 may be customized to display options for modeling the document workflow depending upon the user or the user role. For example, the graphical interface 500 represents an administrator interface, for a bank agent logged into her document banking account using the client device 106-1. The administrator interface 500 may be part of an application running on the client systems 106-1, or a web page opened in a web browser on the client device 106-1 in network communication with the host device 102.

The administrator interface 500 may include the document workflow manager 108 represented by a workflow pack menu 502 including options such as ‘Create’ 502-1, ‘Upload’ 502-2, ‘Saved’ 502-3, ‘Deployed’ 502-4, and ‘Instances’ 502-5. The Create 502-1 option may allow the administrator to create a new document workflow using the workflow editor 202. The Upload 502-2 option may allow the administrator to upload and save a predefined workflow into the document workflow manager 108. The Saved 502-3 option may display a list of document workflows saved in the document workflow manager 108. The Deployed 502-4 option may depict the document workflows which are currently integrated with the document management system 104. The Instances 502-5 option may display a number of standard document workflows to the users for describing the operations for the document workflow manager 108.

Additionally, the administrator interface 500 may include a login/logout section 504 for a user to login or logout from the document workflow manager 108, and a workflow pack avatar section 506 for assessing the interface 500 configured for different user roles, such as administrator, agent, and customer. Further, an address bar 508 may be included to show the hierarchy of options selected by the user in the document workflow manager 108.

As shown, upon selection of the Create option 502-1 on the administrator interface 500, the workflow editor 202 may open in a user window on the administrator interface 500 along with a save button 510. The workflow editor 202 may include various options for creating document workflows using the predefined symbols 511 for representing the intended tasks, modules, flow, etc. The workflow editor 202 may also use various programming languages and techniques for creating documents workflows, for example, a graphical programming language such as Business Process Model and Notation (BPMN).

As shown, a document processing task 512 may be denoted by a rectangular block in the workflow editor 202. The document processing task 512 may indicate the responsible agent 512-1 and the SLA duration 512-2 of the document processing task 512. The responsible agent and a corresponding symbol 512-1 may point to the functional role in the organization that needs to complete the task 512. The SLA duration and a corresponding symbol 512-2 may indicate the designated time duration for completing the task 512. An automated timer (not shown) may be initiated within the document processing task 512 to give regular notifications and alerts to the responsible user roles such as the agent 512-1 according to the SLA duration 512-2. Accordingly, the document processing task 512 and a notification module such as the notification module 114 may always be executed; however, an alert module such as the alert module 112 may be executed when the automated timer exceeds the SLA duration. In addition, the responsible agent 512-1 may be allowed to access the documents, which are located on the database of the document management system 104, required for completion of the task 512. Additionally, the document processing task 512 may indicate other properties of the document processing task 512 as well.

The workflow editor 202 may further include a task property editor 514. The task property editor 514 may include various property fields for a selected document processing task, for example, the document processing task 512. The property fields may include task properties such as name, role, SLA duration, alert, incoming documents, update documents, or the like. The administrator user role may manipulate these properties to create a desired document processing task.

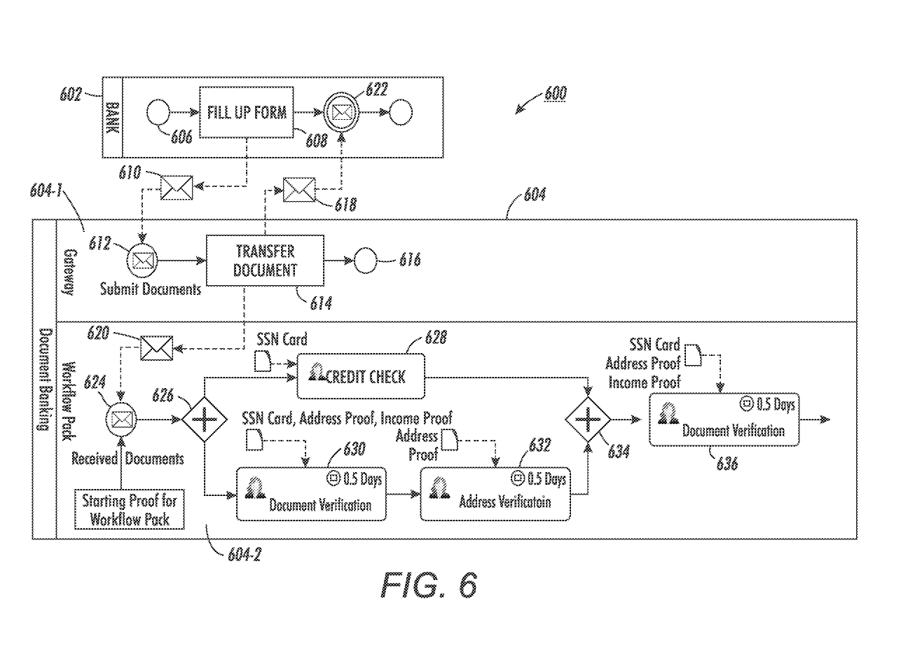

FIG. 6 illustrates an exemplary document workflow 600 created by the document workflow manager 108 for opening a new bank account. The document workflow 600 includes a section 602 to be performed in the bank or on the bank's website, and a section 604 to be performed by the document workflow manager 108 in association with the document management system 104. In the bank section 602, the document workflow 600 includes a task 606 for creating a document banking account for customers. A customer may create the document banking account by visiting the bank website or by physically visiting the bank facilities. Then, the document workflow 600 includes a form filling task 608 that is a document processing task for the customer to fill up a bank account opening form.

The document banking section 604 is divided into two subsections—a gateway section 604-1 and a workflow pack section 604-2 representing the document workflow manager 108. Along with the form filling task 608, there is a notification task 610 that connects the form filling task 608 to a submit documents task 612 in the gateway section 604-1. The submit documents task 612 requests the customer to submit the documents required for the completion of the document workflow 600. After the submit document task 612, there is a document transfer task 614, which transfers the documents submitted by the customer to the document banking database 616. Along with the document transfer task 614, there are two notification tasks 618 and 620. The notification task 618 may be connected to a message task 622, which gives an acknowledgement message to the customer using email, instant message, a pop up, etc. to indicate that the documents and the application form have been transferred. The customer may be then redirected to the bank website. The notification task 620 may be connected to a received documents message task 624, which gives a message to the administrator or appropriate agents within the document workflow that a new application is filed and the attached documents have been received. The message task 624 starts the document workflow within the document workflow manager pack section 604-2.

The message task 624 may be connected to a parallel processing task 626, which initiates two parallel processes. The first parallel process may include a credit check task 628 having properties such as names of agents/bank officials or user roles which are going to perform the task, SLA time limit, and documents required, for example, as shown, a copy of the social security number (SSN) of the customer. The required documents or links to the documents are provided to the agent at the start of credit check task 628. The agent may check the credit of the customer and then send the documents or links to the documents for the next document processing task.

The second parallel process may include a document verification task 630 provides the documents or links to the documents to one or more agents for document verification. Subsequently, the agent may send the documents or links to the documents for the next document processing task.

In addition, the second parallel process may include an address verification task 632. The address proof document is passed to an appropriate agent specified in the properties of the task block for the specified SLA-time period, for example, as shown, 0.5 days. The agent may verify the address and send the documents forward for approval within the predefined SLA time period. The agent involved in these various tasks may attach additional files or notes to the current application and the documents submitted by the customer. The parallel processes are combined again in the close parallel processing task or an inclusive gateway 634. The close parallel processing task 634 may connect to the final approval task 636.

The final approval task 636 transfers all the documents sent by the agents in the previous tasks to an appropriate agent, for example, the account opening approval officer for approval within a specified SLA time period of 1 day. The agent may process the documents within the SLA time period and may approve or reject the application accordingly. The document workflow 600 is only exemplary in nature and the document workflow manager 108 may be used to model a wide variety of document workflows.

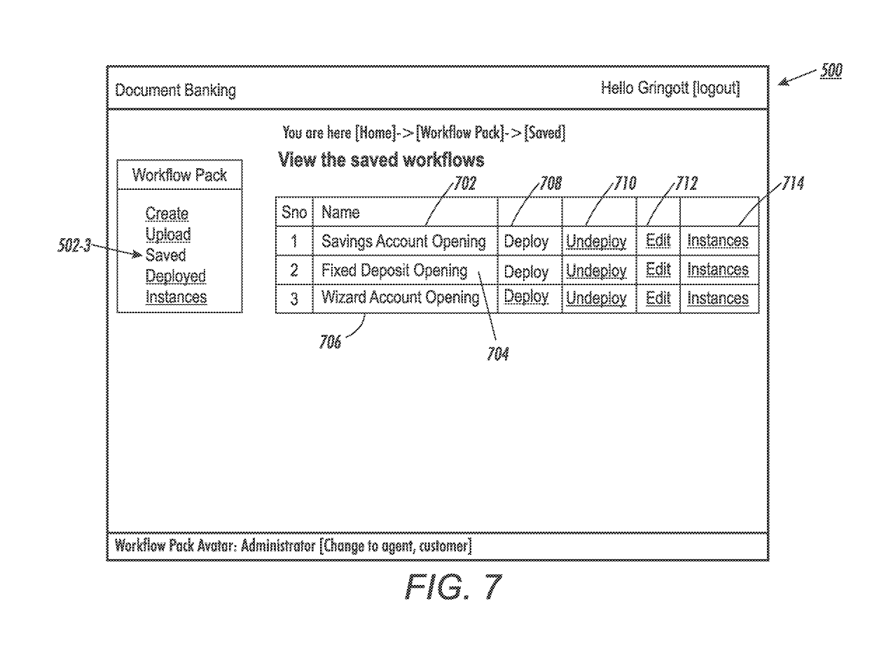

FIG. 7 depicts the administrator interface 500, when the user selects the ‘Saved’ 502-3 option on the Workflow Pack menu 502 representing the document workflow manager 108. The administrator interface 500 also includes a window depicting pre-saved document workflows, namely, a savings account opening workflow 702, a fixed deposit opening workflow 704, and a wizard account opening workflow 706. Each of the workflows 702, 704, and 706 may be associated with the corresponding options such as ‘Deploy’ 708, ‘Undeploy’ 710, ‘Edit’ 712, and ‘Instances’ 714 for manipulating the workflows 702, 704, and 706. An administrator user role may select these options to deploy, undeploy, or edit the workflows 702, 704, and 706 or see instances of similar workflows. Once an administrator user role has deployed one of the document workflows 702, 704, and 706, the integration module 204 may integrate such document workflows with the document management system 104. After deployment, the workflows 702, 704, 706 may become active and the users (e.g., customers of the bank) may initiate the workflow, for example, as shown in the savings account opening workflow 600, shown in FIG. 6.

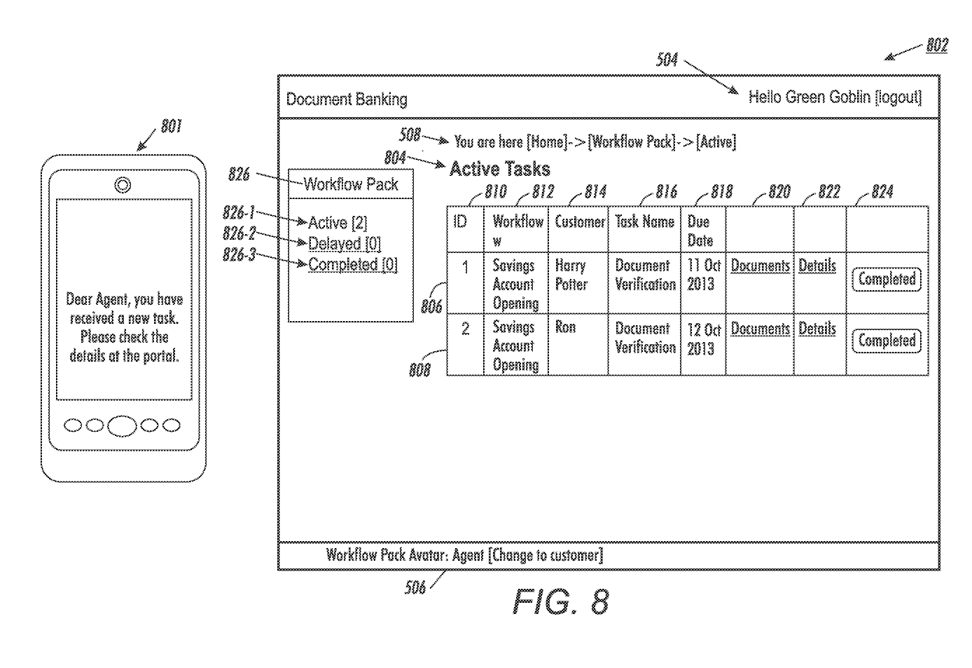

Turning to FIG. 8, an agent may receive a new task alert on her computing device such as a mobile device 801 from the alert module 112 when the runtime engine 206 allocates a new task to the agent. Additionally, the agent may view the document processing tasks allocated to her on an agent graphical interface 802 similar to the administrator interface 500 by logging into the document workflow manager 108 from a client device, for example, the client device 106-2. The agent interface 802 may be a software application executing on the client device 106-2, or a web page opened in a web browser on the client device 106-2 in network communication with the host device 102.

Similar to the administrator interface 500, the agent interface 802 may include the login/logout section 504 for the agents to login or logout from the document workflow manager 108. The agent interface 802 may also include the workflow pack avatar section 506 for switching screen options for different user roles, namely, avatars-agent and customer. The workflow pack avatar section 506 may be accessed by entering the corresponding user credentials in a separate window. The agent interface 802 may further include the address bar 508 to show the hierarchy of options that may be selected in the document workflow manager 108.

Furthermore, as shown, the graphical agent interface 802 may include a list of active tasks 804, for example, two savings account opening requests 806 and 808 of two customers. The active tasks 804 may include any number of tasks assigned to the users in the document workflows designed on the document workflow manager 108. Additionally, the active tasks 804 may include corresponding information of the tasks and various options for the agent. For example, as shown, the tasks 806 and 808 each may include workflow ID 810 (e.g., ‘1’); workflow name 812 (e.g., ‘savings account opening’); customer name 814 (e.g., ‘Harry Potter’); task name 816 (e.g., ‘document verification’); due date 818 (e.g., ‘11 Oct. 2013’); an option ‘Documents’ 820 to view or download documents; an option ‘Details’ 822 to view details of the document processing task; and a status indicator 824 (e.g., ‘incomplete’ or ‘complete’).

The agent may download the documents for processing by selecting the option ‘Documents’ 820. The agent may process the documents on a client device (such as the client device 106-2) and upload the documents again to the database associated with the document workflow manager 108 after completion of the document processing task to manually or automatically change the status indicator 824 from ‘incomplete’ to ‘complete’. In some embodiments, the unprocessed copies of the documents may be automatically removed from the database after completion of the document processing task. Further, the agent may upload additional documents and notes for the agents of the next document processing task. For example, the agent conducting address verification may upload a note for the agent responsible for final approval to indicate errors in an address proof.

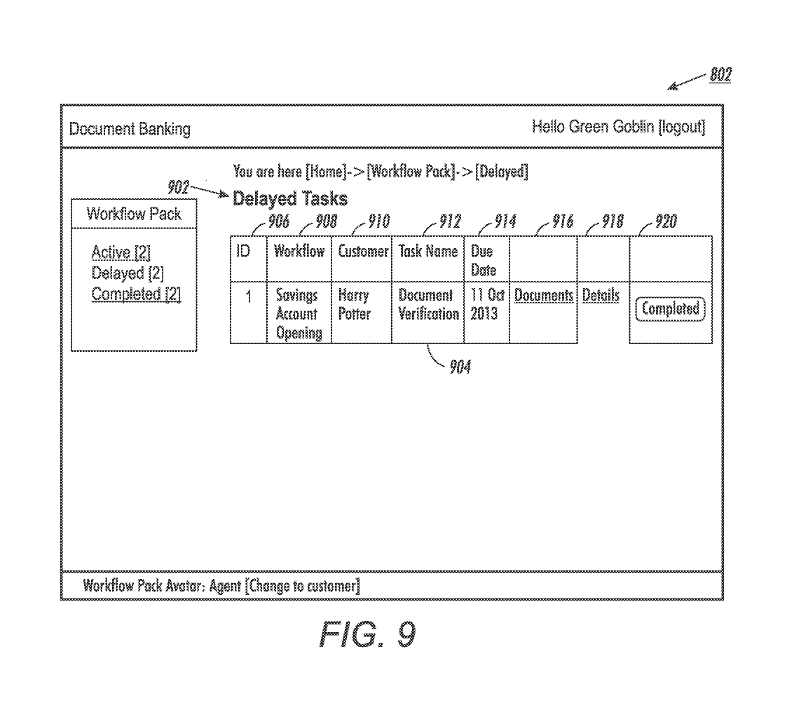

Similar to the administrator interface 500, the agent interface 802 may include a workflow pack menu 826. The workflow pack menu 826 may include an option ‘Active’ 826-1 to view active tasks, an option ‘Delayed’ 826-2 to view delayed tasks, and an option ‘Completed’ 826-3 to view completed tasks. The agent may select these options to view and act upon the tasks allocated to her accordingly. For example, as shown in FIG. 9, the agent may select the option ‘Delayed’ 826-2 in the agent interface 802 to view the delayed tasks. A list of delayed tasks 902 may be displayed to the agent on the agent interface 802. The list 902 may include the delayed tasks, for example, a task 904 for opening a new savings account for a customer named Harry Potter. The list 902 may include details of the task, such as Workflow ID 906, Workflow name 908, Customer name 910, Task name 912, Due date 914, ‘Documents’ 916 for viewing or downloading, ‘Details’ 918 for viewing task details, and a status indicator 920.

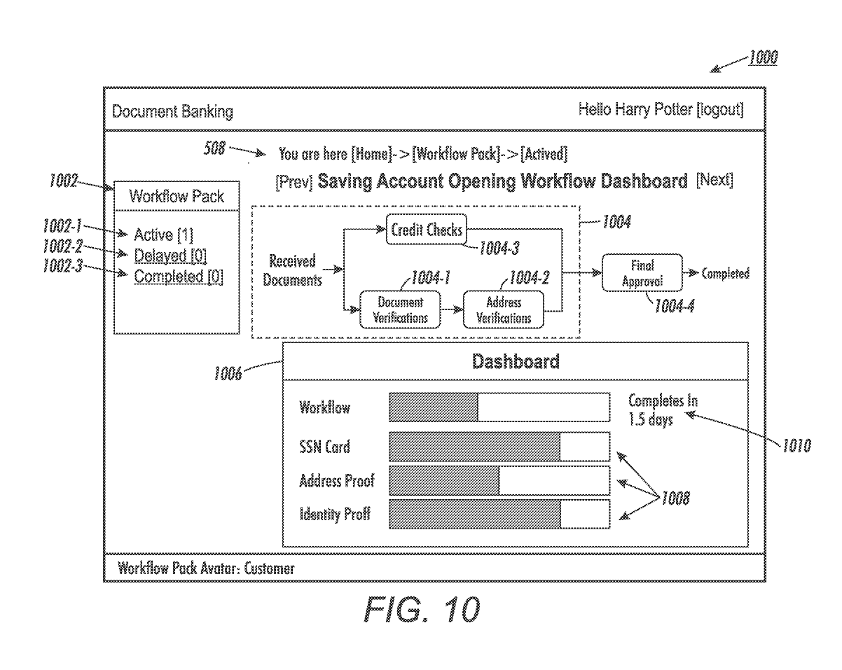

Turning to FIG. 10, a customer may view the status of the workflows and associated tasks initiated by her service requests, in a customer graphical interface 1000, on a client device, for example, the client device 106-3, by logging into the document workflow manager 108. The customer interface 1000 may be a software application running on the client device 106-3, or a web page opened in a web browser on the client device 106-3 in network communication with the host device 102.

Further, the customer interface 1000 may include the login/logout section 504 for the customers to login or logout from the document management system 104; the workflow pack avatar section 506 depicting the customer user role; and the address bar 508 to show hierarchy of options that are selected in the document workflow manager 108.

Further, the customer interface 1000 may include a workflow pack menu 1002. The workflow pack menu 1002 may include options such as ‘Active’ 1002-1, ‘Delayed’ 1002-2, and ‘Completed’ 1002-3 to view active, delayed, and completed workflow tasks respectively. For example, as shown, the option ‘Active’ 1002-1 may be selected by the customer.

The customer interface 1000 may include a workflow 1004 and a dashboard 1006. The workflow 1004 may indicate a list of tasks included in a document workflow to the customer for opening a savings account. The document processing tasks in the workflow 1004 may include different numeric indicators, alphanumeric indicators, or non-alphanumeric indicators, such as different colors, different color luminance, different patterns, different textures, different graphical objects, etc. to indicate different stages of the tasks to the customer. For example, a document verification task 1004-1 may be colored green to indicate that the task has been completed. A credit check task 1004-2 and an address verification task 1004-3 may be colored yellow to indicate that the tasks are currently in operation, and a final approval task 1004-4 may be colored grey to indicate that the task has not been started.

The dashboard 1006 may include one or more of these indicators to show the time taken by each task, for example, the dashboard 1006 may include progress bars 1008 to indicate the time taken to complete the workflow and individual tasks, such as SSN card check, Address proof verification, and Identity proof verification. Similar to the colored representation of document processing tasks in the workflow 1004, the progress bars 1008 may be colored to indicate the stages of completion of the tasks. Additionally, an estimated time of completion 1010 may be also indicated on the dashboard 1006. Further, the dashboard 1006 may include additional information, for example, the agent or functional role responsible for carrying out each document processing task.

Further, the customer interface 1000 may indicate delays in one or more document processing tasks. For example, the document verification task 1004-1 in the workflow 1004 may be shown with a red color to indicate that the task is delayed. Additionally, few progress bars 1008 in the dashboard 1006 may be colored red to indicate delay in the workflow and a corresponding document processing tasks with respect to the associated SLA duration. In such instances, the customer interface 1000 may allow the customer to raise appropriate flags to the user roles, such as administrator, who may be a bank manager in a banking scenario if the workflow is not completed by the SLA parameter threshold, such as the SLA time or duration threshold of 1.5 days.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

What is claimed is:

1. A device for managing document workflows, the device for use with a communication network, the device comprising:
a workflow editor for configuring a document workflow based on at least one service level agreement (SLA) parameter, wherein the configured document workflow includes one or more document processing tasks;
an integration module configured to:
establish communication between the configured document workflow and a document management system; and
retrieving a document from the document management system in response to at least one service request; and
a runtime engine configured to:
execute the one or more document processing tasks on the retrieved document according to the configured document workflow; and
generate at least one of a notification and an alert based on statuses of the one or more document processing tasks with respect to the at least one SLA parameter.

2. The device of claim 1, further comprising a status monitor configured to monitor statuses of the one or more document processing tasks upon a user request, periodically, or continually.

3. The device of claim 1, wherein the integration module is further configured to integrate the configured document workflow with the document management system.

4. The device of claim 1, wherein the workflow editor is further configured to:
save the configured document workflow;
edit the configured document workflow;
deploy the configured document workflow; and
undeploy the deployed configured document workflow.

5. The device of claim 1, wherein the configured document workflow is saved in the document management system.

6. The device of claim 1, wherein the notification and the alert are at least one of a message, an audio indication, and a visual indication.

7. The device of claim 1, wherein the SLA parameter includes the expected time duration for task completion.

8. The device of claim 1, wherein the workflow editor is further configured to provide an interactive user interface at a remote device for managing the document workflow over the communication network.

9. The device of claim 1, wherein the one or more document processing tasks are represented using at least one predefined symbol.

10. A method for managing document workflows, the method comprising:
configuring and deploying a document workflow based on at least one service level agreement (SLA) parameter, wherein the document workflow includes one or more document processing tasks;
establishing communication between the configured document workflow and a document management system;
retrieving a document from the document management system in response to at least one service request received from a first user role;
accessing the retrieved document to perform the one or more document processing tasks by a second user role; and
generating at least one of a notification and an alert based on statuses of the one or more document processing tasks with respect to the at least one SLA parameter.

11. The method of claim 10, wherein the step of configuring the document workflow comprises representing the one or more document processing tasks using at least one symbol.

12. The method of claim 10, wherein establishing communication between the configured document workflow and a document management system includes integrating the configured document workflow and the document management system.

13. The method of claim 10, further comprising monitoring status of the one or more document processing tasks upon a user request, periodically, or continually.

14. The method of claim 10, further comprising at least one of: saving the configured document workflow in the document management system, editing the configured document workflow, or undeploying the deployed configured document workflow.

15. The method of claim 10, wherein accessing the retrieved document includes manipulating the retrieved document.

16. The method of claim 15, wherein the manipulated document is stored in the document management system, or passed to at least one of the first user role and the second user role, or both.

17. The method of claim 10, wherein the notification and the alert are at least one of a message, an audio indication, and a visual indication.

18. The method of claim 10, wherein the SLA parameter includes the expected time duration for task completion.

19. The method of claim 10, wherein the first user role and the second user role are same.

20. The method of claim 10, wherein at least one of the first user role and the second user role includes an administrator, an agent, or a customer.

21. The method of claim 10, further comprising providing an interactive user interface at a remote device for managing the document workflow over a network.

22. The method of claim 10, wherein the first user role and the second user role are preconfigured with the document management system.

23. A system for managing a document workflow in a network of computing devices, the system comprising:
a host device including a document management system; and
a client device in communication with the host device, the client device configured with:
an administrator interface assisting to configure and deploy a document workflow based on at least one service level agreement (SLA) parameter, the configured document workflow includes at least one document processing task, wherein the configured document workflow being integrated with the document management system;
a customer interface assisting to send a service request for retrieving a document from the document management system, wherein the host device is configured to:
retrieve the document based on the service request;
provide the retrieved document for the at least one document processing task; and
execute the at least one document processing task according to the document workflow based on an agent input; and
an agent interface assisting to receive a notification based on the at least one document processing task and the retrieved document being available for access.

24. The system of claim 23, further comprising a status interface assisting to monitor status of the at least one document processing task upon a user request, periodically, or continually.

25. The system of claim 23, the administrator interface further assists to at least one of: save the configured document workflow in the document management system, edit the configured document workflow, or undeploying the deployed configured document workflow.

26. The system of claim 23, wherein the notification is at least one of a message, an audio indication, and a visual indication.

27. The system of claim 23, wherein customer interface further assists to receive an alert based on the at least one document processing task violating the at least one SLA parameter.

28. The system of claim 23, wherein the SLA parameter includes the expected time duration for task completion.
